(19) United States
(12) Patent Application Publication
(10) Pub. No.: US 2006/0252973 A1
(43) Pub. Date: Nov. 9, 2006

(54) Liquid mercury containing device and method for reducing toxicity of liquid mercury in liquid mercury containing device

(76) Inventors: Marco Aimi, Saratoga Springs, NY (US); Timothy Eric Beerling, San Francisco, CA (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 11/123,375

(22) Filed: May 6, 2005

(51) Int. Cl. B09B 3/00

(52) U.S. Cl. 588/249; 588/900

(57) ABSTRACT

Device and method for reducing toxicity of a toxic material in a toxic material containing device. A toxic material containing device has a first chamber containing a toxic material and a second chamber containing a neutralizing material capable of reducing the toxicity of the toxic material when the toxic material and the neutralizing material are combined. A control mechanism enables selective combining of the toxic material and the neutralizing material to provide a combined material that is less toxic than the toxic material. The device and method enable the toxicity of a toxic material in a device, such as liquid mercury in a liquid mercury containing device, to be reduced to a safe level to facilitate safe disposal of the device.

### DESCRIPTION OF RELATED ART

Liquid mercury can be found in many important products including thermometers, switches and relays. Liquid mercury, however, is highly toxic; and, as a result, devices that contain liquid mercury are receiving substantial attention in today's environmentally conscious climate. Of particular concern is the disposal of devices that contain liquid mercury. Typically, such devices are disposed of with the mercury contained therein in a liquid state. As a result, there is a risk that mercury can leak from the devices, thus adversely affecting the environment and creating a possible health risk.

Because of concerns regarding the use of liquid mercury, the disposal of devices that contain liquid mercury has become an active topic for governmental intervention. For example, regulations currently in effect in many jurisdictions limit the amount of liquid mercury that may be included in a device, and some regulations include requirements that will eventually result in a complete ban of the use of liquid mercury in consumer devices. In Europe, regulations are currently under discussion that would regulate homogeneous materials that contain more than 0.1 percent mercury by weight. These regulations, when enacted, may apply to all devices (with the exception of medical, and control and monitoring equipment) that contain liquid mercury as well as to devices that contain mercury bound in another state, such as mercury containing alloys.

In general, current and future regulations that control the use and disposal of devices that contain liquid mercury or other toxic materials are significantly limiting the marketability of such devices.

### SUMMARY OF THE INVENTION

In accordance with the invention, a toxic material containing device and a method for reducing toxicity of a toxic material in a toxic material containing device is provided. A toxic material containing device has a first chamber containing a toxic material, and a second chamber containing a neutralizing material capable of reducing the toxicity of the toxic material when the toxic material and the neutralizing material are combined. A control mechanism enables selective combining of the toxic material and the neutralizing material to provide a combined material that is less toxic than the toxic material. The device and method enable the toxicity of liquid mercury or other toxic materials contained in a device to be reduced to an acceptable level to facilitate safe disposal of the device.

### BRIEF DESCRIPTION OF THE DRAWINGS

Furthermore, the invention provides embodiments and other features and advantages in addition to or in lieu of those discussed above. Many of these features and advantages are apparent from the description below with reference to the following drawings.

FIG. 1 schematically illustrates a liquid mercury switch according to an exemplary embodiment in accordance with the invention;

FIG. 2 schematically illustrates the liquid mercury switch of FIG. 1 in the process of being modified to reduce the toxicity of the liquid mercury therein according to an exemplary embodiment in accordance with the invention;

FIG. 3 schematically illustrates the liquid mercury switch of FIG. 1 after being modified to reduce the toxicity of the liquid mercury therein according to an exemplary embodiment in accordance with the invention;

FIG. 4 schematically illustrates a liquid mercury switch according to a further exemplary embodiment in accordance with the invention; and

FIG. 5 is a flowchart that illustrates a method for reducing toxicity of a toxic material in a toxic material containing device according to an exemplary embodiment in accordance with the invention.

### DETAILED DESCRIPTION OF THE EXEMPLARY EMBODIMENTS OF THE INVENTION

Exemplary embodiments in accordance with the invention provide a toxic material containing device and a method for reducing toxicity of a toxic material in a toxic material containing device.

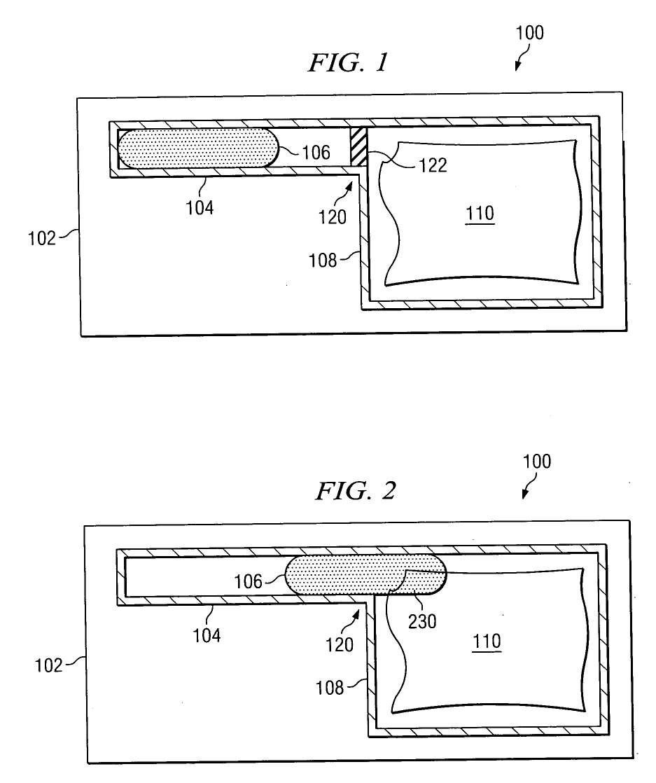

FIG. 1 schematically illustrates a liquid mercury switch according to an exemplary embodiment in accordance with the invention. The switch is generally designated by reference number 100 and includes switch body 102 having first chamber 104 for containing liquid mercury 106, and second chamber 108 for containing neutralizing material 110 capable of reducing the toxicity of liquid mercury.

Neutralizing material 110 in second chamber 108 is a material that is capable of combining with liquid mercury to form a compound containing both mercury and the neutralizing material and that is less toxic than liquid mercury. According to an exemplary embodiment in accordance with the invention, neutralizing material 110 is a metal or a metal alloy that is capable of both absorbing and combining with liquid mercury to form an intermetallic alloy. Examples of neutralizing materials that will absorb and combine with liquid mercury to form an intermetallic alloy include gold, tin and indium, although it is not intended to limit the invention to any particular neutralizing material. In many applications, in fact, the particular neutralizing material selected will depend on the type and size of the device and the ease with which the neutralizing material can be incorporated in the device.

Second chamber 108 containing neutralizing material 110 is preferably positioned within body 102 of liquid mercury switch 100 in such a manner that it will not interfere with the performance of switch 100, for example, by causing premature mixing of the liquid mercury and the neutralizing material, or by undesirably affecting the RF performance of the switch. First chamber 104 and second chamber 108 are, however, positioned relative to one another to provide interface 120 therebetween. Interface 120 enables communication between chambers 104 and 108 so that liquid mercury 106 in first chamber 104 can flow into second chamber 108 and combine with neutralizing material 110 in second chamber 108 to provide a combined material that is less toxic than liquid mercury.

Control mechanism 122 is positioned at interface 120 to selectively control combining of the liquid mercury and the neutralizing material. In particular, control mechanism 122 is a mechanism that will normally close interface 120 to prevent liquid mercury 106 in first chamber 104 from flowing into second chamber 108 to combine with neutralizing material 110. According to an exemplary embodiment in accordance with the invention, control mechanism 122 prevents liquid mercury 106 and neutralizing material 110 from combining during normal use of switch 100. When, however, it is desired to dispose of switch 100, for example, when switch 100 has reached the end of its useful life, control mechanism 122 is enabled to allow liquid mercury 106 to flow through interface 120 into second chamber 108 to combine with neutralizing material 110.

Control mechanism 122 may take several forms. In the exemplary embodiment in accordance with the invention illustrated in FIG. 1, control mechanism 122 comprises a seal that normally closes interface 120. When it is desired to dispose of switch 100, seal 122 is removed to enable liquid mercury 106 in first chamber 104 to flow into second chamber 108 and combine with neutralizing material 110.

FIG. 2 schematically illustrates the liquid mercury switch of FIG. 1 in the process of being modified to reduce the toxicity of the toxic material therein according to an exemplary embodiment in accordance with the invention. As shown in FIG. 2, seal 122 has been removed and is no longer in place; and liquid mercury 106 is in the process of flowing through interface 120 into second chamber 108 and combining with neutralizing material 110 to provide combined material 230 in second chamber 108.

Seal 122 can be removed from interface 120 in several ways. For example, seal 122 can be a burst seal formed of a frangible material such as glass or plastic, and removed by physically crushing switch 100 to shatter the seal, or by over-pressurizing first chamber 104 to cause the liquid mercury in first chamber 104 to push against and shatter the seal. Alternatively, seal 122 can be formed of a meltable material such as paraffin, and melted when it desired to dispose of switch 100. Melting of the seal can be readily accomplished, for example, by activating one or more heating mechanisms provided in the switch in the vicinity of seal 122.

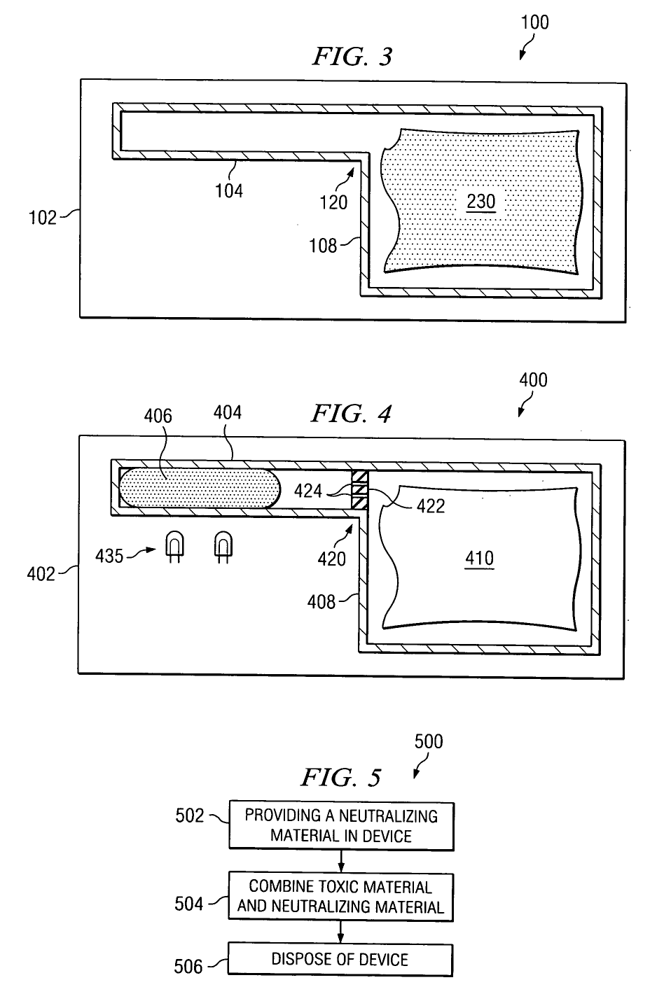

After seal 122 has been removed from interface 120, liquid mercury 106 in first chamber 104 is free to flow into second chamber 108 to combine with neutralizing material 110 to provide combined material 230 that is less toxic than liquid mercury. FIG. 3 schematically illustrates the liquid mercury switch of FIG. 1 after being modified to reduce the toxicity of the liquid mercury therein according to an exemplary embodiment in accordance with the invention. As shown in FIG. 3, all the liquid mercury in first chamber 104 has now flowed into second chamber 108 and has combined with the neutralizing material to provide combined material 230 in second chamber 108.

The period of time required for the liquid mercury to fully combine with neutralizing material 110 to provide combined material 230 depends on the particular neutralizing material used, the quantities of liquid mercury and neutralizing material to be combined and on other factors. In exemplary embodiments in accordance with the invention, it may require several days up to several weeks or more for the materials to fully combine. In this regard, it is usually desirable to provide neutralizing material 110 in a shape that will maximize its surface area in order so as to cause the liquid mercury to more rapidly be absorbed by and to combine with the neutralizing material.

According to an exemplary embodiment in accordance with the invention, the quantity of neutralizing material 110 in second chamber 108 is selected such that the percentage of liquid mercury in combined material 230 will be sufficiently small that the toxicity of combined material 230 is at a level to permit safe disposal of the switch. Preferably, also, the percentage of liquid mercury in combined material 230 will be sufficiently small so as to satisfy any governmental regulations regarding the disposal of mercury containing devices. For example, by providing a quantity of material 110 in second chamber 108 that is at least 1000 times greater than the quantity of liquid mercury 106 in first chamber 104, the combined material will contain no more than 0.1 percent mercury, by weight which, it is believed, will satisfy current and anticipated future regulations regarding the handling of mercury.

In accordance with an exemplary embodiment in accordance with the invention, liquid mercury switch 100 is a miniaturized liquid mercury switch for use on integrated circuit chips or the like. The quantity of liquid mercury 106 in first chamber 104 in such a device will typically be less than about 100 micrograms. Accordingly, in order to reduce the toxicity of the liquid mercury therein to a safe level, about 100,000 micrograms (100 milligrams) of neutralizing material will be required. In other liquid mercury containing devices, the quantity of liquid mercury in first chamber 104 can be much larger; and it is not intended to limit the invention to a device containing any particular quantity of liquid mercury.

FIG. 4 schematically illustrates a liquid mercury switch according to a further exemplary embodiment in accordance with the invention. The liquid mercury switch is generally designated by reference number 400 and includes switch body 402 containing control mechanism 422 normally closing interface 420 between first chamber 404 containing liquid mercury 406, and second chamber 408 containing neutralizing material 410. Control mechanism 422 is a capillary mechanism having a plurality of capillaries 424 extending therethrough. During normal operation of switch 400, capillary mechanism 422 will close interface 420 and prevent liquid mercury from flowing into second chamber 408. When, however, it is desired to dispose of the switch, capillary mechanism 422 is enabled to cause the liquid mercury to flow through capillaries 424 into second chamber 408 to combine with the neutralizing material in the second chamber.

According to an exemplary embodiment in accordance with the invention, capillary mechanism 422 can include internal heaters 435 or another mechanism to create a pressure gradient between chambers 404 and 408 to drive the liquid mercury through capillaries 424. Alternatively, capillary mechanism 422 may comprise an electrowetting capillary mechanism for moving the liquid mercury from first chamber 404 to second chamber 408 using an electrostatic force.

FIG. 5 is a flowchart that illustrates a method for reducing toxicity of a toxic material in a toxic material containing device according to an exemplary embodiment in accordance with the invention. The method is generally designated by reference number 500, and begins by providing a neutralizing material in the device that is capable of reducing the toxicity of the toxic material in the device (Step 502). When it is desired to dispose of the toxic material containing device, for example, when the device has fulfilled its useful life, the toxic material and the neutralizing material are combined to form a combined material that is less toxic than the toxic material (Step 504). The device is then disposed of in a safe, efficient manner (Step 506).

While what has been described constitute exemplary embodiments in accordance with the invention, it should be recognized that the invention can be varied in numerous ways without departing from the scope thereof. For example, although exemplary embodiments in accordance with the invention described herein comprise liquid mercury switches, it should be understood that the present invention encompasses other liquid mercury containing devices including mercury thermometers, mercury tipped reed relays, mercury switches of any size, or another liquid mercury containing device; and it is not intended to limit the invention to any particular liquid mercury containing device. It should additionally be understood that the present invention encompasses devices that contain toxic materials other than liquid mercury, for example, liquid mercury alloys, and it is not intended to limit the invention to a toxic material containing device containing any particular type of toxic material.

Because embodiments in accordance with the invention can be varied in numerous ways, it should be understood that the invention should be limited only insofar as is required by the scope of the following claims

We claim:

1. A toxic material containing device, comprising:
a first chamber containing a toxic material;
a second chamber containing a neutralizing material capable of reducing the toxicity of the toxic material; and
a control mechanism for selectively combining the toxic material and the neutralizing material to provide a combined material that is less toxic than the toxic material.

2. The device according to claim 1, wherein the first material comprises liquid mercury.

3. The device according to claim 2, wherein the neutralizing material comprises a metal.

4. The device according to claim 3, wherein the combined material comprises an intermetallic alloy.

5. The device according to claim 3, wherein the quantity of neutralizing material in the second chamber is at least 1000 times greater by weight than the quantity of liquid mercury in the first chamber to provide a combined material comprising no more than about 0.1 percent mercury by weight.

6. The device according to claim 3, wherein the neutralizing material comprises a metal selected from the group consisting of gold, tin and indium.

7. The device according to claim 2, wherein the device comprises a liquid mercury switch.

8. The device according to claim 7, wherein the liquid mercury switch comprises a miniaturized liquid mercury switch for use on printed circuit chips.

9. The device according to claim 1, wherein the control mechanism comprises a seal at an interface between the first and second chambers.

10. The device according to claim 9, wherein the seal comprises a seal selected from the group consisting of a breakable seal and a meltable seal.

11. The device according to claim 1, wherein the control mechanism comprises a capillary mechanism at an interface between the first and second chambers.

12. A method for reducing toxicity of a toxic material in a toxic material containing device, comprising:
providing a neutralizing material in the device capable of reducing the toxicity of a toxic material in the device; and
combining the toxic material and the neutralizing material to provide a combined material that is less toxic than the toxic material.

13. The method according to claim 13, and further including:
disposing of the device after providing the combined material.

14. The method according to claim 12, and further comprising:
preventing the toxic material and the neutralizing material from combining during a period prior to combining the toxic material and the neutralizing material.

15. The method according to claim 14, wherein the period comprises a period during which the toxic material containing device is being used.

16. The method according to claim 12, wherein the toxic material comprises liquid mercury, and wherein the toxic material containing device comprises a liquid mercury containing device.

17. The method according to claim 16, wherein the quantity of neutralizing material in the second chamber is at least 1000 times greater by weight than the quantity of liquid mercury in the first chamber to provide a combined material that comprises no more than about 0.1 percent mercury by weight.

18. A liquid mercury containing device, comprising:
a first chamber in the device containing liquid mercury;
a second chamber in the device containing a neutralizing material capable of reducing the toxicity of the liquid mercury;
an interface between the first and second chambers; and
a control mechanism at the interface for combining the toxic material and the neutralizing material to provide a combined material that is less toxic than the toxic material to permit safe disposal of the device.

19. The device according to claim 18, wherein the liquid mercury containing device comprises a liquid mercury switch.

20. The device according to claim 18, wherein the combined material comprises a compound containing no more than about 0.1 percent mercury by weight.
